(19) United States
(12) Patent Application Publication
(10) Pub. No.: US 2004/0181963 A1
(43) Pub. Date: Sep. 23, 2004

(54) Glove dryer

(76) Inventor: Sherilyn G. Morris, Fritz Creek, AK (US)

Correspondence Address: Sherilyn G. Morris, P.O. Box 15064, Pritz Creek, AK, 99603, US

(21) Appl. No.: 10/391,635

(22) Filed: Mar. 20, 2003

(51) Int. Cl. F26B 25/00

(52) U.S. Cl. 34/103; 34/104; 34/239; 34/621; 211/85.3; 211/34; D32/58

(57) ABSTRACT

An insert is disposed in a glove to open up the glove and allow the flow of drying air to the inner surfaces of the glove. A cruciform shaped opening is provided in a central portion of the insert. The opening is adapted to interlock with a mating cruciform member on a drying tree for drying in ambient air. Alternatively, the insert with glove mounted thereon can be disposed in a mechanical dryer (electric or gas) if desired.

### BACKGROUND OF THE INVENTION

1. Field of the Invention

The present invention generally relates to drying apparatus. More specifically, the present invention is drawn to apparatus for mounting gloves in an open configuration to permit drying air to be directed inside the glove.

2. Description of the Related Art

People who are active in winter climes, camping, skiing, snow machining, etc., often face the problem of maintaining a pair of dry gloves. Gloves that are hung overnight by the fire never seem to completely dry out. Even gloves that are deposited in a mechanical dryer (electrical or gas), still retain some dampness. The major drawback to complete drying is the lack of access of drying air to the inside surfaces of the gloves. A device that is portable, compact and easy-to-use, which device could be utilized in ambient air or mechanical drying would certainly be a welcome addition to the art.

There are many devices in the prior art utilized to open and dry gloves. Examples of such devices are shown in U.S. Pat. No. 5,406,717 (Dofka) and U.S. Pat. No. 6,085,436 (Peet). Neither patent contemplates the concept of depositing the glove-opening devices in a mechanical dryer. Both patents show structure for drying only a single pair of gloves at a time.

U.S. Pat. No. 4,209,913 (Wallin et al.) and U.S. Pat. No. 5,125,169 (Bader) disclose glove-drying members shaped to resemble a human hand. No provision is made to dry multiple gloves and no provision is made to deposit the member in a mechanical dryer if desired.

The patents to Appelet (U.S. Pat. No. 3,477,622) and Varnado (U.S. Des. 243, 313) are drawn to glove drying devices that can support multiple pairs of gloves. The devices are not suitable for use in mechanical dryers.

U.S. Pat. No. 5,117,565 (Willenbacher, Jr.) discloses a wire mesh drying frame configured as a human hand. The frame requires multiple parts including a wrist portion and a mounting clip.

U.S. Pat. No. 5,604,993 (Aukerman) and U.S. Pat. No. 5,983,518 (Ellenburg) show glove drying devices that are equipped with an electrically operated fan for supplying drying air to the interior of the glove. No provision is made to dry multiple pairs of gloves.

U.S. Pat. No. 5,003,707 (Chu) and U.S. Pat. No. 5,379,525 (Raynor) are drawn to devices for drying ski boots.

None of the above inventions and patents, taken either singularly or in combination, is seen to disclose a glove-drying device suitable for both ambient air and mechanical drying as will be subsequently described and claimed in the instant invention.

### SUMMARY OF THE INVENTION

The present invention is drawn to an insert that is disposed in a glove to open up the glove and allow the flow of drying air to the inner surfaces of the glove. The insert is of skeletal construction and is fabricated light-weight material for easy portability. A cruciform shaped opening is provided in a central portion of the insert. The opening is adapted to interlock with a mating cruciform member on a drying tree for drying in ambient air. Alternatively, the insert with glove mounted thereon can be disposed in a mechanical dryer (electric or gas) if desired.

Accordingly, it is a principal object of the invention to provide a glove-drying device, which device ensures thorough drying.

It is another object of the invention to provide a glove-drying device, which device permits ambient air or mechanical drying.

It is a further object of the invention to provide a glove-drying device, which is portable and easy to use.

Still another object of the invention is to provide a glove-drying device, which device can accommodate multiple pairs of gloves.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a glove dryer according to the present invention.

FIG. 2 is an exploded, perspective view of a glove and insert therefore according to the present invention.

FIG. 3 is a perspective view of a glove insert in a collapsed state, according to the present invention.

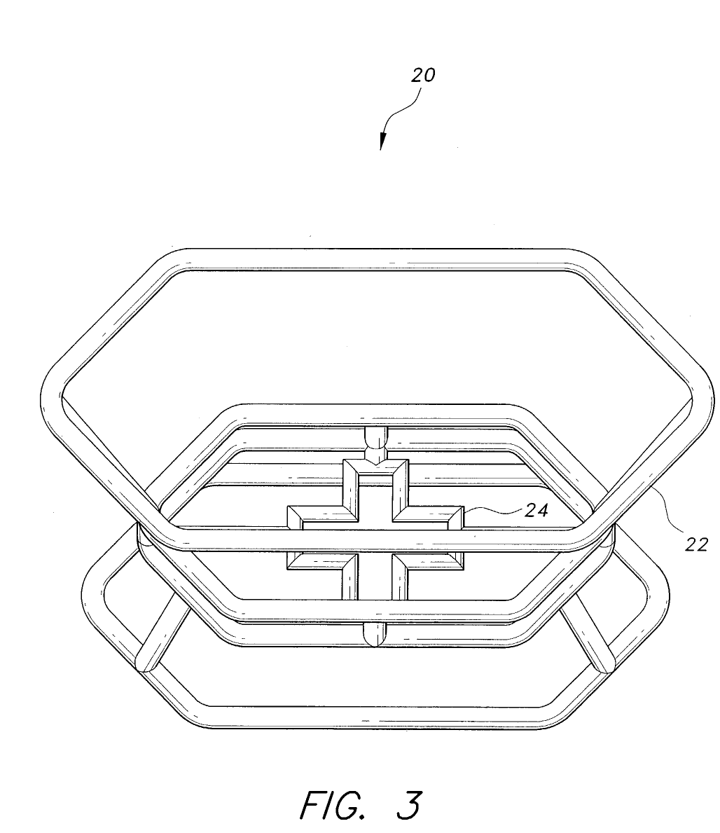

FIG. 4 is a partial view showing the middle section of the insert, according to the present invention.

FIG. 5 is a partial view showing the interlock portion the glove dryer tree, according to the present invention.

Similar reference characters denote corresponding features consistently throughout the attached drawings.

### DETAILED DESCRIPTION OF THE PREFERRED EMBODIMENT

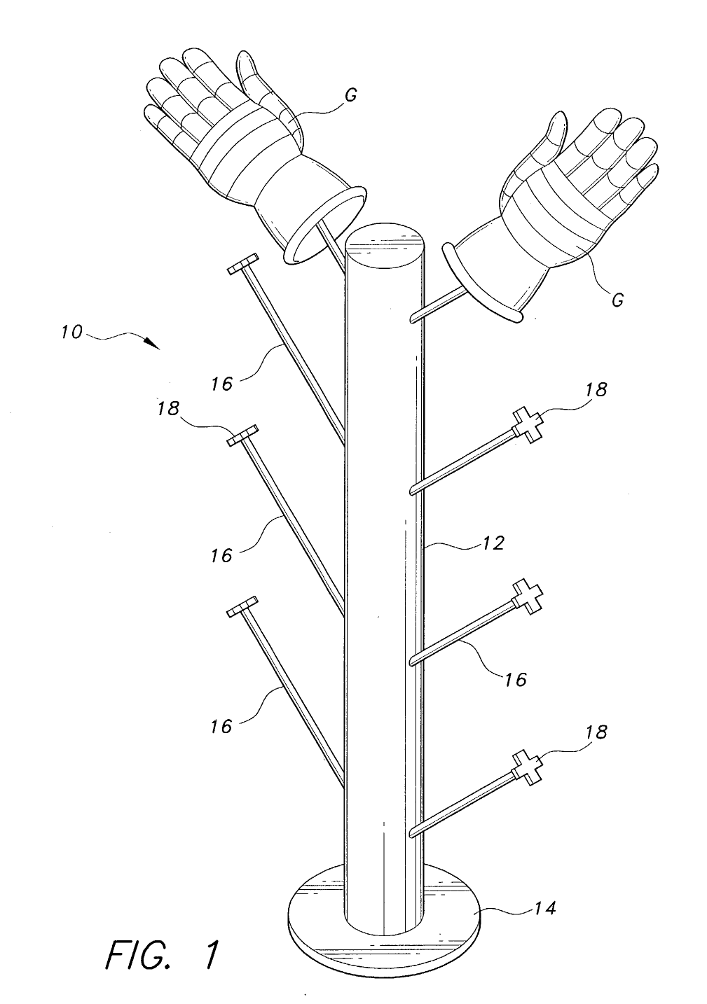

Attention is first directed to FIG. 1, wherein the drying device is generally indicated at 10.

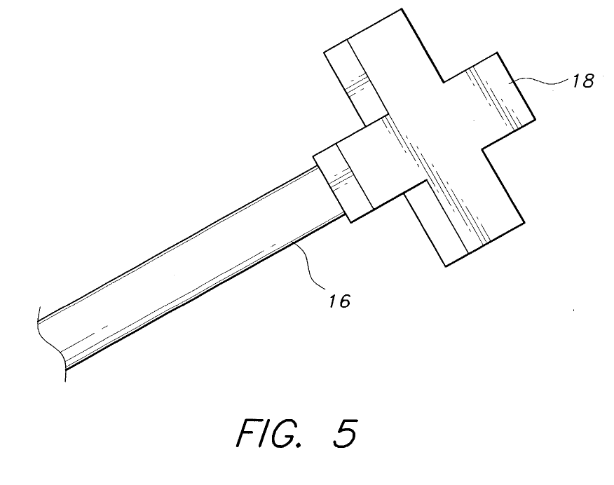

The device comprises a drying tree having a trunk 12 and a base 14. Trunk 12 is removably mounted in base 14. An array of tree limbs 16 is removably mounted in trunk 12. As best seen in FIG. 5, each limb 16 has a distal end that terminates in a cruciform shaped member 18 whose function will be explained below. Gloves G are mounted on the limbs 16 to be dried by ambient air. It has been determined that the most efficient drying occurs when the limbs 16 extend upwardly at a forty-five degree angle from the trunk of the tree.

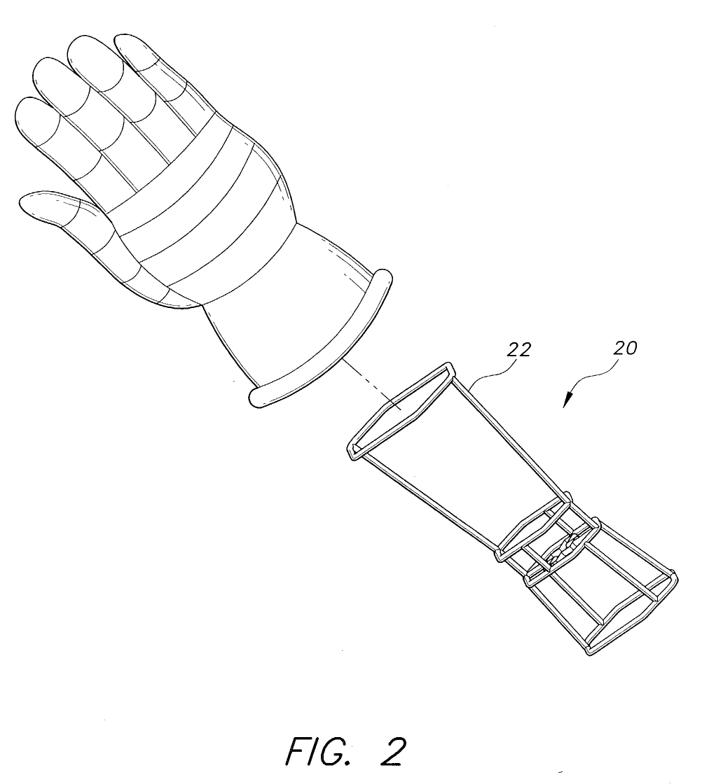

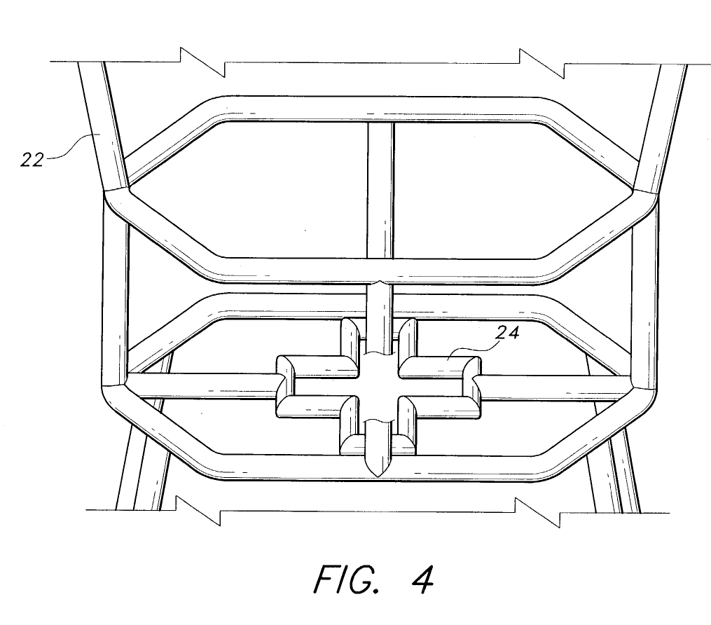

An insert member 20 (FIG. 2) is disposed inside glove G before the glove is positioned on limb 16. Insert 20 is fabricated from a flexible, heat resistant, light-weight material (fabric covered plastic or metal, for example) 22. In its expanded state, the insert is configured as double truncated cones. As best seen in FIG. 4, an inner portion of insert 20 is formed with a cruciform shaped opening 24. Opening 24 is designed with approximately the same dimensions as member 18 so that insert 20 can be interlocked with limb 16.

The above arrangement allows multiple pairs of gloves to be mounted on the tree for drying.

When not in use, the tree may be taken apart and the inserts collapsed for easy portability. Since the inserts are fabricated from heat-resistant material, the glove mounted inserts may be placed in a mechanical dryer for drying if such dryer is available.

It is to be understood that the present invention is not limited to the embodiment described above, but encompasses any and all embodiments within the scope of the following claims.

I claim:

1. A glove dryer comprising:
a drying tree, said drying tree adapted to support gloves thereon for drying in ambient air, said drying tree including;
a base member;
a trunk member, said trunk member removably mounted in said base member;
an array of limbs, each limb of said array removably mounted in said trunk member and extending upwardly at an angle therefrom, each said limb terminating in a distal end;
a cruciform shaped member, said cruciform shaped member defining said distal end; and
a glove-opening insert, said insert being mounted on said cruciform shaped member.

2. A glove dryer as recited in claim 1, wherein each limb member extends upwardly at an angle of forty-five degrees.

3. A glove dryer as recited in claim 1, wherein said insert is configured as truncated double cones.

4. A glove dryer as recited in claim 1, wherein said insert is fabricated from a flexible, heat-resistant material.

5. A glove dryer as recited in claim 1, wherein said insert has a central portion and said central portion has an opening therein.

6. A glove dryer as recited in claim 5, wherein said opening is configured as a cruciform.

7. A glove dryer comprising:
a drying tree, said drying tree adapted to support gloves thereon for drying in ambient air, said drying tree including;
a base member;
a trunk member, said trunk member removably mounted in said base member;
an array of limbs, each limb of said array removably mounted in said trunk member and extending upwardly at an angle of forty-five degrees therefrom, each said limb terminating in a distal end;
a cruciform shaped member, said cruciform shaped member defining said distal end;
a glove-opening insert, said insert being mounted on said cruciform shaped member, said insert being fabricated from a flexible, heat-resistant material and configured as truncated double cones.

8. A glove dryer as recited in claim 7, wherein said insert has a central portion and said central portion has an opening therein.

9. A glove dryer as recited in claim 8, wherein said opening is configured as a cruciform.

10. A glove-opening insert for opening a glove to permit drying air therein, said insert comprising:
a skeletal frame, said frame being fabricated from a flexible, heat-resistant material and configured as a double cone;
a central portion formed on said frame; and
an opening disposed in said central portion, said opening being configured as a cruciform.

11. A glove-opening insert as recited in claim 10, wherein said flexible, heat-resistant material is a fabric covered metallic material.

12. A glove-opening insert as recited in claim 10, wherein said flexible, heat-resistant material is a fabric covered plastic material.
